(19) United States
(12) Patent Application Publication
(10) Pub. No.: US 2026/0156119 A1
(43) Pub. Date: Jun. 4, 2026

(54) AUTHENTICATION MANAGEMENT COMPUTER FOR IDENTITY AUTHENTICATION, AND IDENTITY AUTHENTICATION SYSTEM AND IDENTITY AUTHENTICATION METHOD USING AUTHENTICATION MANAGEMENT COMPUTER

(71) Applicant: Seong Min YOON, Guri-si (KR)

(72) Inventor: Seong Min YOON, Guri-si (KR)

(21) Appl. No.: 19/464,684

(22) Filed: Jan. 30, 2026

Related U.S. Application Data
(62) Division of application No. 18/023,540, filed on Feb. 27, 2023, now abandoned.

(30) Foreign Application Priority Data
Sep. 1, 2020 (KR) 10-2020-0111186

(51) Int. Cl. H04L 9/40

(52) U.S. Cl. CPC H04L 63/102; H04L 63/083; H04L 63/20

(57) ABSTRACT

The present invention relates to an authentication management computer. The authentication management computer of the present invention includes at least one hardware processor and a memory storing program for managing the performance of the identity authentication that causes the computer to perform: receiving identity verification information of the authentication requester provided by a related person of the authentication requester, receiving consent information to identity verification information generated by a non-related person of the authentication requester based on the identity verification information; and performing the identity authentication of the authentication requester based on the identity verification information of the related person and the consent information of the non-related person.

### CROSS-REFERENCE TO RELATED APPLICATIONS

This application is a divisional of U.S. patent application Ser. No. 18/023,540, filed Aug. 25, 2021, which is incorporated herein by reference in its entirety.

### TECHNICAL FIELD

The present invention relates to an authentication management computer for identity authentication, and an identity authentication system and an identity authentication method using the authentication management computer. More particularly, the present invention relates to an authentication management computer for identity authentication, and an identity authentication system and an identity authentication method using the authentication management computer which, when a user needs authentication to receive various services such as financial services and certificate issuance, eliminates the inconvenience of using specific devices such as repetitive public certificates and OTPs for authentication, and presenting identification cards, etc., and certifies the identity of the authentication requester through related persons of the authentication requester who have requested identity authentication, which can prevent user authentication by fraudulent methods, and preferably non-related persons who are related to the above related persons but are not related to the authentication requester.

### BACKGROUND ART

Various security measures are used to prevent fraudulent authentication such as theft for identity authentication performed to receive various services. However, since there is always a possibility of fraudulent authentication by means of forgery, alteration, theft, hacking, or the like, various security measures are being developed to lower the possibility.

In Japanese Patent Laid-Open No. 2019-040557 (published on Mar. 14, 2019), there is published an authentication system, an authentication method, an authentication apparatus, and a program thereof.

The disclosed invention (1) is an invention relating to an authentication system comprises: a data acquisition unit that acquires, from a terminal of an authentication target, related party information indicating one or more first related parties related to the authentication target; and an authentication processing unit that specifies one or more second related parties related to the authentication target from the first interested parties on the basis of the related party information indicating related parties related to the first related parties, and performs authentication processing on the authentication target on the basis of the second related parties.

In addition, in Korean Patent Laid-Open No. 10-2016-0077102 (published on Jul. 1, 2016), there is published a peer based authentication.

The disclosed invention (2) related to confirming an identity of a first user of a first user device. An aspect includes receiving a request to confirm the identity of the first user, determining whether or not there is a relationship between the first user or the first user device and a second user of a second user device or the second user device based on a first list of user interactions associated with the first user device and a second list of user interactions associated with the second user device, and confirming the identity of the first user based on determining that there is a relationship between the first user or the first user device and the second user or the second user device.

In addition, in Korean Patent registration No. 10-1949470 (Feb. 18, 2019), there is registered a user context-based authentication method with enhanced security, interactive AI agent system, and computer-readable recording medium.

The disclosed invention (3) relates to user context-based authentication method with enhanced security, interactive AI agent system, and computer-readable recording medium. An aspect includes obtaining user identification information; searching for user authentication data from a user database based on the user identification information, wherein the user database includes characteristics data of each user, and the authentication data includes a question/answer list including at least one question generated based on the characteristics data of each user included in the user database and including at least one answer semantically related to each question; providing one question selected from the searched list of questions/answers to a user terminal; receiving an answer to the provided question from the user terminal; and performing user authentication based on the received answer.

In the disclosed invention (1), authentication is performed based only on the authentication target and related party information by acquiring at least one related party information of the authentication target person. Therefore, an error may occur in user authentication due to mocking between the authentication target and the person concerned.

In the disclosed invention (2), authentication of the first user is performed based on determining that there is a relationship between the first user or the first user device and the second user or the second user device. Therefore, an error may occur in authentication of the first user due to mocking between the first user and the second user.

In addition, the patented invention performs user authentication depending on a query to a person to be authenticated and an answer from the person to be authenticated, and there is a problem in that it is difficult to secure objectivity of user authentication.

Therefore, there is a need for an following invention capable of secure the reliability of identity authentication for user authentication is desired.

It does not depend only on the identity verification performed by the related person of the authentication requester of the user authentication, but the identity verification is also performed by non-related persons who are not related to the authentication requester, and in the relationship between the related persons and the non-related persons participating in the verification of identity of the authentication requester, identity verification of the related persons is performed by the non-related persons, thereby securing reliability of identity verification.

### SUMMARY OF THE INVENTION

The present invention has been made in an effort to provide an authentication management computer for identity authentication, and an identity authentication system and an identity authentication method using the authentication management computer that performs identity verification through identity verification performed by a related person of the authentication requester, and identity verification performed by non-related persons who are not related to the authentication requester.

In addition, the present invention has been made in an effort to provide an authentication management computer for identity authentication, and an identity authentication system and an identity authentication method using the authentication management computer capable of ensuring the reliability of identity authentication by allowing identity authentication of the related persons to be performed by the non-related persons in a relationship between the related persons and non-related persons participating in the identity verification.

According to a first aspect of the present invention, there is provided an authentication management computer of performing identity authentication for user authentication of authentication requester.

The authentication management computer includes at least one hardware processor and a memory storing program for managing the performance of the identity authentication that causes the computer to perform: receiving identity verification information of the authentication requester provided by a related person of the authentication requester, receiving consent information to identity verification information generated by a non-related person of the authentication requester based on the identity verification information; and performing the identity authentication of the authentication requester based on the identity verification information of the related person and the consent information of the non-related person.

According to a second aspect of the present invention, there is provided an authentication management computer of performing identity authentication for user authentication of authentication requester.

The authentication management computer includes at least one hardware processor and a memory storing program for managing the performance of the identity authentication that causes the computer to perform: providing communication details between the authentication requester and a related person of the authentication requester to a non-related person terminal of a non-related person who is not related to the authentication requester; receiving identity verification information of an authentication requester generated by the non-related person through analysis of the communication details; and performing identity verification of the authentication requester based on the identity verification information generated by the non-related person.

According to a third aspect of the present invention, there is provided an authentication management computer of performing identity authentication for user authentication of authentication requester.

The authentication management computer includes at least one hardware processor and a memory storing program for managing the performance of the identity authentication that causes the computer to perform: receiving communication details between the authentication requester and a related person related to the authentication requester and communication details between the related person and a non-related person unrelated to the authentication requester; analyzing the communication details and generating identity verification information of the authentication requester; and performing identity authentication of the authentication requester based on the generated identity verification information.

According to a fourth aspect of the present invention, there is provided an identity verification system using one of the first to third aspects of the authentication management computer.

According to a fifth aspect of the present invention, there is provided an identity authentication method using an authentication management computer that performs identity authentication for user authentication of an authentication requester including: receiving, by the authentication management computer, identity verification information of the authentication requester provided by a related person of the authentication requester; receiving, by the authentication management computer, consent information for identity verification information generated by a non-related person of the authentication requester based on the identity verification information; and Performing, by the authentication management computer, identity authentication of the authentication requester based on the identity verification information of the related person and the consent information of the non-related person.

According to a sixth aspect of the present invention, there is provided an identity authentication method using an authentication management computer that performs identity authentication for user authentication of an authentication requester including: providing, by the authentication management computer, communication details between the authentication requester and a related person of the authentication requester to a non-related person terminal of a non-related person who is not related to the authentication requester; receiving, by the authentication management computer, identity verification information of an authentication requester generated by the non-related person through analysis of the communication details; and performing, by the authentication management computer, identity verification of the authentication requester based on the identity verification information generated by the non-related person.

According to a seventh aspect of the present invention, there is provided an identity authentication method using an authentication management computer that performs identity authentication for user authentication of an authentication requester including: receiving, by the authentication management computer, communication details between the authentication requester and a related person related to the authentication requester and communication details between the related person and a non-related person unrelated to the authentication requester; analyzing, by the authentication management computer, the communication details and generating identity verification information of the authentication requester; and performing, by the authentication management computer, identity authentication of the authentication requester based on the generated identity verification information.

### Effect of Invention

According to the present invention, it is possible to secure reliability of identity verification by performing the user authentication of the authentication requester through identity verification by non-related persons unrelated to the authentication requester as well as identity verification by related person related to the authentication requester.

In addition, since the authentication requester's identity verification is possible only when the identity of the authentication requester's related persons and non-related persons confirms the identity, it is possible to solve problems such as fraudulent use and hacking of identity authentication means by supplementing the vulnerability of personal information security, which is performed only with the name, photo and phone number of the authentication requester during identity authentication.

In addition, when the authentication requester requests identity authentication again, only the authentication requester's personal information is confirmed and identity authentication information of the related and non-related persons stored is used to approve the identity authentication, so that the identity authentication procedure is simple and convenient.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic configuration diagram of an exemplary embodiment of an identity authentication system of the present invention;

FIG. 2 is a schematic configuration diagram of an example of an authentication management computer which is a main part in the exemplary embodiment of the identity authentication system of the present invention;

FIG. 3 is a schematic configuration diagram of an example of an authentication request information management module which is the main part in the exemplary embodiment of the authentication management computer of the present invention;

FIG. 4 is a schematic configuration diagram of an example of an authentication information management module which is the main part in the exemplary embodiment of the authentication management computer of the present invention;

FIG. 5 is a schematic configuration diagram of an example of a data analysis computer which is a main part in the exemplary embodiment of the identity authentication system of the present invention;

FIG. 6 is a schematic configuration diagram of an example of a related person identity performing management module which is the main part in the exemplary embodiment of the data analysis computer of the present invention;

FIG. 7 is a schematic configuration diagram of an example of a data storage computer which is a main part in the exemplary embodiment of the identity authentication system of the present invention;

FIG. 8 is a schematic configuration diagram of an example of an analysis data storage computer which is a main part in the exemplary embodiment of the identity authentication system of the present invention;

FIG. 9 is a flowchart for describing an exemplary embodiment of an identity authentication method of the present invention.

FIG. 10 is a flowchart for describing another exemplary embodiment of an identity authentication method of the present invention.

FIG. 11 is a flowchart for describing another exemplary embodiment of an identity authentication method of the present invention.

FIG. 12 is a flowchart for describing another exemplary embodiment of an identity authentication method of the present invention.

FIG. 13 is a schematic configuration diagram of another exemplary other embodiment of an identity authentication system of the present invention;

FIG. 14 is a schematic configuration diagram of an example of an authentication management computer which is a main part in the exemplary embodiment of the identity authentication system of FIG. 13 of the present invention.

### DETAILED DESCRIPTION OF THE PREFERRED EMBODIMENT

Hereinafter, exemplary embodiments of the present invention will be described in detail with reference to the accompanying drawings.

For convenience of the description of the exemplary embodiments of the present invention, among terms used in the description of the exemplary embodiments of the present invention to be described below, configurations of the present invention may refer to configurations of hardware itself and also refer to configurations of a web program or computer program executed by using the hardware resources.

For example, the authentication management computer and data analysis computer of the present invention can be composed of each hardware component included in the computer, and each component of the web program or computer program stored in the storage means of the computer can be composed of a central processing unit (CPU) that includes commands and algorithms stored in the computer's registers, utilizing the hardware resources of the CPU.

In addition, the terms ‘˜part’, ‘˜module’, ‘˜means’ or ‘˜unit’ used in the embodiment description of the present invention can be used with the same meaning of the same configuration, and terms that can be appropriately substituted according to the action of the configuration element can be used. These terms may be hardware configurations of computers or terminals and may represent each component of a web program or computer program that is executed under the control of a central processing unit (CPU) or at least one hardware processor.

In the embodiment of the present invention, the above terms are mainly used as terms representing each component of a web program or computer program. In addition, terms or expressions not defined herein are not necessarily related to the terms or expressions, but of course, have a greater meaning in terms of the action or function of the component represented. Also, the terms used in the embodiment of the present invention, such as acquaintances, related parties, and surrounding persons, may be used for the same meaning.

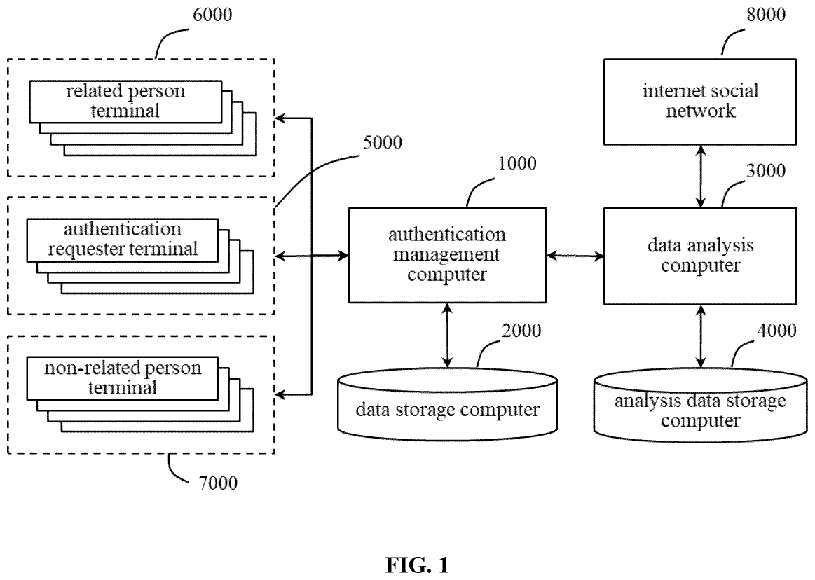

FIG. 1 is a schematic configuration diagram of an exemplary embodiment of an identity authentication system of the present invention. As illustrated in FIG. 1, the identity authentication system of the present invention is a configuration including an authentication management computer 1000 which manages information on related persons of the authentication requester of the requester for personal authentication and information on at least one related person group distinguished by the nature of the related persons and Information on related persons of the authentication requester of the requester for personal authentication and information on at least one related person group distinguished by the nature of the related persons, and manages an identity verification of the authentication requester by the related persons or the non-related persons and user authentication information based on the identity verification of the authentication requester; a data storage computer 2000 which stores data including an authentication requester information of the user authentication managed by the authentication management computer 1000, related persons and related person group information, cell phone text messages of related persons, messages sent and received using chatting application programs on mobile phones, voice calls using Internet call service, e-mail and communication details information including text of social network service (SNS), voice using voice communication program, etc., a non-affiliated person and unrelated person group information unrelated to the authentication requester, and an Identity confirmation information of the authentication requester; a data analysis computer 3000 which generates a big data database by analyzing information such as daily conversations between acquaintances and information such as words used during conversations collected through Internet social networks, etc., receives communication detail information of a related person or group of related persons according to a personal authentication request from the authentication management computer 1000 to perform identification verification; receives identity confirmation information generated by non-related persons based on the identity confirmation information of the related persons from non-related persons having a relationship with the related person but not related to the authentication requester, and transmits the same to the authentication management computer (1000); an analysis data storage computer 4000 which stores an analysis data including a big data database generated by collecting and analyzing in the data analysis computer (3000), information analyzed by the data analysis computer 3000 on the communication details of the related persons or related person groups received from the authentication management computer 1000, and analyzing various data received from the non-related persons or non-related person groups and based on this, analysis data including big data database generated by collecting and analyzing in the data analysis computer (3000); a user authentication approval request means provided in the authentication requester terminal (5000) of the authentication requester that is connected to the authentication management computer (1000) to request personal authentication and to receive user authentication approval information; a related person identity verification providing means provided in at least one related person terminal (6000) connected to the authentication management computer 1000 by communication which provides relationship information and communication details with the authentication requester by related persons such as acquaintances who related to the authentication requester to the authentication management computer (1000); a non-related identity verification providing means provided in at least one non-related terminal (7000) connected to the authentication management computer 1000 by communication in which non-related person who have no relationship with the authentication requester or non-related person who have a relationship with the related person but have no relationship with the authentication requester are provided with identity verification information of the related person regarding the authentication requester from the data analysis computer 3000; and a social network such as the Internet Social Relationship Network 8000 to collect data such as words, phrases, or expressions that characterize the relationship between people, connected by the data analysis computer 3000.

The authentication management computer 1000 may be configured as at least one server computer, which is equipped with a communication means, includes at least one hardware processor and a memory for storing programs, and is driven to control the execution of a computer program or web program of the present invention stored in the memory for performing the embodiment of the present invention, at least one hardware processor.

The data analysis computer 3000 may be configured as at least one server computer having communication means and capable of executing an artificial intelligence (AI) related computer program or web program.

The data storage computer 2000 and the analysis data storage computer 4000 may be configured as a database management system (DBMS).

The authentication requester terminal 5000, related person terminal 6000, and non-related person terminal 7000 are equipped with communication means and may be configured with terminals such as smart phones, tablet computers, personal computers (PCs), and laptop computers that can execute an application program or web program.

The application program or web program provided in the authentication requester terminal 5000 may be configured as a personal authentication approval request means for requesting personal authentication approval from the authentication management computer 1000.

The application program or web program provided in the related person terminal 6000 may be configured as a related person identity verification providing means for providing the authentication management computer 1000 with relation information and communication details with the person who requested the user authentication.

The application program or web program provided in the non-related person terminal 7000 may be configured as a non-related person identity verification providing means that provides relation information and communication details with the related person to the authentication management computer 1000.

The internet social network 8000 is a configuration that can include various social network services (SNS) and Internet media.

In the configuration of the above embodiment of the present invention, when the authentication requester terminal 5000 requests user authentication, the authentication management computer 1000 receives information including phone numbers of related persons such as acquaintances of the authentication requester and communication details with related persons from the authentication requester terminal 5000, and based on this, the authentication management computer 1000 requests an identity verification of the authentication requester and communication details with acquaintances other than the authentication requester to the related person terminal 6000 of the related persons, and the authentication management computer 1000 receives the identity verification information of the authentication requester transmitted from the related person terminal 6000 and the communication details information with related persons including acquaintances other than the authentication requester, so that the related persons of the related persons set them as non-related persons of the authentication requester.

The authentication management computer 1000 transmits identity verification information performed by related persons of the authentication requester who are related to the non-related persons to the non-related person terminal 7000 used by the non-related persons, and the computer requests confirmation whether the related persons who have verified the identity are the related persons of the non-related person.

The authentication management computer 1000 receives the identity verification information of the related persons transmitted from the non-related person terminal 7000, and the authentication requester information, the information of the related persons who have sent the identity verification information of the authentication requester, and transmits the information of the non-related persons who have sent the identity verification information of the related person, and requests the identity authentication of the authentication requester.

The data analysis computer 3000 uses the Internet social network 8000 such as various portal sites and social networks on the Internet for relational data including words, phrases, expressions, etc. that can establish a relationship between people and people. It accesses and collects and updates relational data.

The computer collects and updates relational data collected from the internet social network 8000 such as various portal sites and social networks on the internet with relational data that includes words, phrases, and expressions that can establish relationships between people it owns.

The data analysis computer 3000 extracts relationship data capable of specifying the relationship between people from the communication details between the authentication requester and related persons and the communication details between the related persons and non-related persons, determines the consistency between the relation data it possesses and the extracted relation data, and if the match is equal to or higher than a certain ratio, the identity verification data of the authentication requester is generated and transmitted to the authentication management computer 1000.

The authentication management computer 1000 approves the identity authentication of the authentication requester based on the identity authentication data of the authentication requester transmitted from the data analysis computer 3000 and stores the identity authentication data, and at the same time, transmits the user authentication data to the authentication requester terminal 5000.

If the information of the communication details is voice information, the corresponding information may be analyzed using voice recognition technology, or by using a voice matching method or a voice-to-text conversion technique.

The relationship information between the related persons and the authentication requester, and the relationship between the related persons and non-related persons may include, for example, family, relatives, friends, co-workers, schoolmates, friendship members, and hobbyists.

In addition, the communication details information of the related persons and non-related persons includes various types of communication information performed using mobile phones including, for example, mobile phone text messages (SMS, MMS, etc.), chatting messages in chatting application programs running on mobile phones, text messages on social network services (SNS), e-mail letters, Internet voice calls on mobile phones, and the like.

In the embodiment of the identity authentication system of the present invention, the function of the data analysis computer 3000 is performed by the authentication management computer 1000, and the data analysis computer 3000 may be omitted.

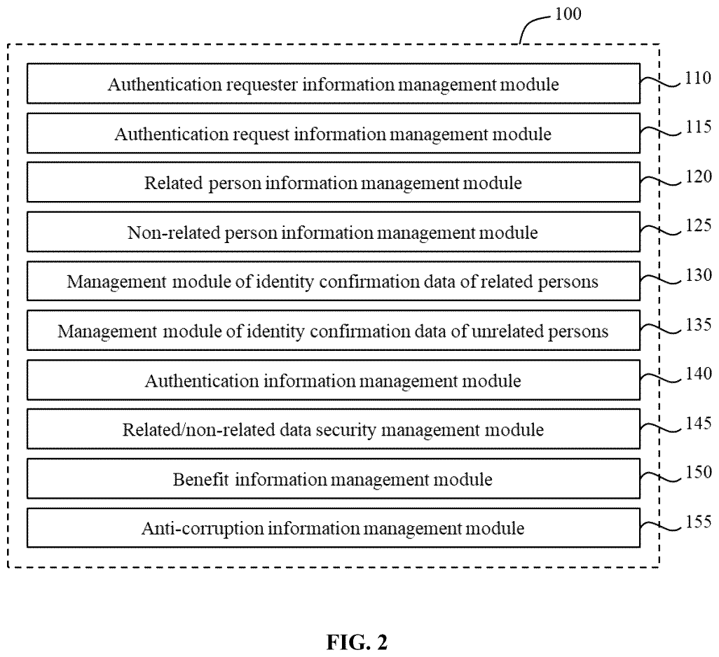

FIG. 2 is a schematic configuration diagram of an example of an authentication manager computer which is a main part in the exemplary embodiment of the authentication management system of the present invention.

The configuration of FIG. 2 may consist of a web program utilizing hardware resources (hardware processor, memory, etc.) of the authentication management computer 1000 or identity authentication management means expressing each component of a computer program as a module. The modules of each configuration are stored in the memory of the authentication management computer 1000 and implement the operation of the identity authentication system of the present invention under the control of hardware processors.

As illustrated in FIG. 2, the identity authentication management means 100 composed of a computer program or the like that is executed in the authentication management computer 1000 of the present including:

an authentication requester information management module 110 which receives personal information and at least one password information of the authentication requester entered into the authentication requester terminal 5000 by the authentication requester who wants to perform user authentication, and stores and manages in the data storage computer 2000; an authentication request information management module 115 which receives and manages user authentication request data including personal information including the name and face photo or name and mobile phone number of the authentication requester entered into the authentication requester terminal 5000 and consent information on the use of information of related persons, such as acquaintances of the authentication requester, prior consent information in providing information of related persons stored in the terminal in use, such as mobile phone or personal computer (PC) of the authentication requester; a related persons information management module 120 which receives and manages information of related persons including mobile phone numbers, e-mail addresses, SNS addresses, etc. of related persons transmitted from the authentication requester terminal (5000) and communication details information with the related persons; a non-related persons information management module 125 which receives non-related person information including mobile phone numbers, e-mail addresses, SNS addresses, etc. of non-related persons of the authentication requester who are related to related persons, including acquaintances of related persons, excluding the authentication requester transmitted from the related person terminal 6000 by the related persons and communication details information with the related person, and stores and manages in connection with the information of the related persons; a related person verification data management module 130 which requests an identity verification of the authentication to the related person terminal of the related persons, and stores and manages identity verification data of the related persons transmitted from the related person terminal; a non-related person verification data management module 135 which transmits identity verification information data of the authentication by the related person and information of the related persons to the non-related person terminal 7000 of each non-related person related to the related person, and receives and manages the identity verification data transmitted from the non-related person terminal 7000 and information on whether the person concerned agrees to confirm the identity of the certification requester, and receives and managing relation identity confirmation data of non-affiliated persons transmitted from the non-affiliated party terminal 7000 and information on whether or not to consent to the identity verification of the authentication requester by related persons; an authentication information management module 140 which transmits data including information of the authentication requester and communication details information of the non-related persons who have verified the identity of the authentication requester and non-related persons who have agreed to the identity verification of the authentication by the related persons to the data analysis computer, and requests identity authentication, and receives identity authentication data of the authentication requester transmitted from the data analysis computer 3000 and performs and manages user authentication of the authentication requester; a related person/non-related person data security management module 145 which performs encryption and decryption of information data and personal information of related persons and non-related persons received from the related person terminal 6000 and the non-related person terminal 7000; a benefit information management module 150 which stores and manages benefit information including points granted to related persons and non-related persons who agreed to the request for verification of whether the person is the same as the authentication requester while providing information on the related persons and non-related persons, etc.; and an anti-corruption information management module 155 which filters out false information provided by the authentication requester or related persons or non-related persons for fraudulent purposes, and for assigning and managing penalty points to cheaters.

The related person information management module 120 may group related persons of the authentication requester into categories such as, for example, family, relatives, friends, work, school, friendship, and hobbies to generate and manage related person groups.

The non-related person information management module 125 groups the non-related people who are related people of the authentication requester into categories such as, for example, family, relatives, friends, work, school, friendship, hobbies to generate and manage non-related person groups.

Security of information data and personal information of related persons and non-related persons in the related person/non-related person data security management module 145 is encrypted and stored to protect communication details and their contents, and the communication history and its contents can be decrypted, analyzed, and then encrypted and stored again after the analysis process.

In addition, it is possible to analyze and process without decryption of communication details and contents encrypted by homomorphic encryption technology or the like.

In addition, for example, even though the authentication requester and related persons, or related persons and non-related persons do not know each other, there may occur cases where user authentication by a person other than the authentication requester or user authentication for a person other than the authentication requester is performed for fraudulent purposes.

In order to prevent identity authentication for such fraudulent purposes, the anti-corruption information management module 155 may use a method of checking the name through a bank account opened in the name of the authentication requester or confirming the validity of the name of the mobile phone of the authentication requester in use through password confirmation.

The motive for illegal use of the identity authentication system of the present invention can be blocked by taking measures such as imposing a strong penalty on an illegal user or deducting a reliability score index.

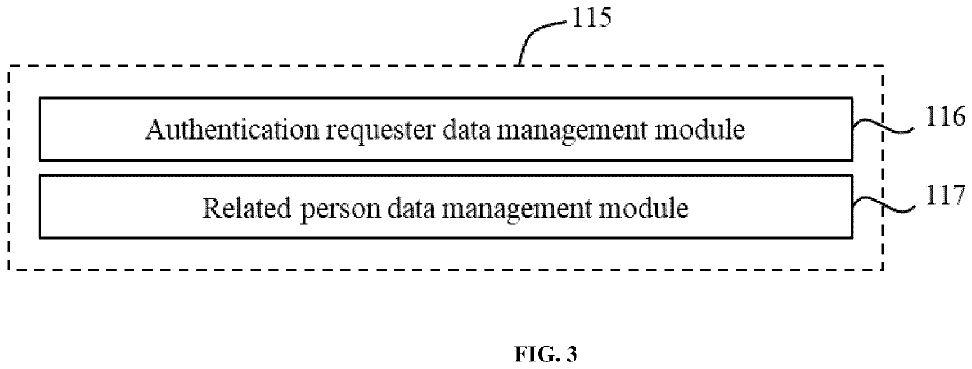

FIG. 3 is a schematic configuration diagram of an example of an authentication request information management module which is the main part in the exemplary embodiment of the authentication management computer of the present invention.

As illustrated in FIG. 3, the authentication request information management module 115 includes an authentication requester data management module 116 which receives and manages data related to information of related persons such as acquaintances who know the authentication requester stored in the electronic devices capable of communicating with external communication media including name and face photo, or name and mobile phone number entered and transmitted by the authentication requester who requested user authentication in the authentication requester terminal 5000, and mobile phone, tablet computer, laptop computer, or personal computer being used by the authentication requester, and a related person data management module 117 which stores and manages data such as related person information, cell phone number, e-mail address, and various social network service access addresses of the related person among the related person information.

If the face photo or mobile phone number input from the authentication requester terminal 5000 managed by the authentication requester data management module 116 is different from the previously managed one, the authentication management computer 1000 records the change history can be stored and managed.

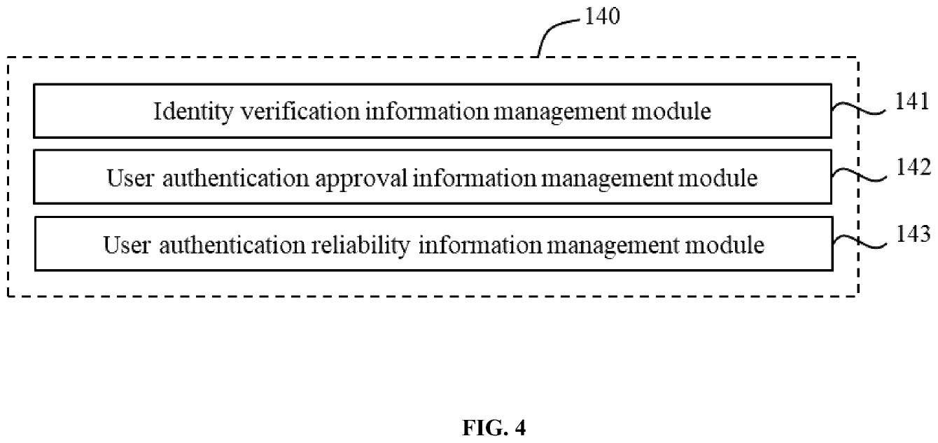

FIG. 4 is a schematic configuration diagram of an example of an authentication information management module which is the main part in the exemplary embodiment of the authentication management computer of the present invention.

As illustrated in FIG. 4, the authentication information management module 140 includes an identity verification information management module 141 which receives and manages an identity verification information derived by analyzing based on information provided by related persons and non-related persons to the authentication requester as the same person; a user authentication approval information management module 142 which generates the user authentication approval information based on the identity verification information and transmits and manages the user authentication approval information to the an authentication requester terminal 5000 of the requester of user authentication; and a user authenticator reliability information management module 143 which stores and manages reliability granting and reliability upgrade information to the person who has been approved for the user authentication.

Regarding the reliability of the person who has been approved for the user authentication managed by the user authenticator reliability information management module 143, a reliability index score of 80 points may be given, for example, when the user authentication is approved for the first time, and if data is additionally analyzed and authenticated by the data analysis computer 3000 due to an increase in communication details in the future, a reliability index score may be additionally assigned according to a predetermined criterion.

The predetermined criterion for adding the reliability indicator score may be determined in proportion to, for example, the number of related persons and non-related persons who participated in the user verification, the total number of related person groups and non-related person groups, and the total period during which messages were transmitted and received, may be determined based on a numerical value that is proportional or inversely proportional to the average user of each item.

At least one password input by the user who wants to be authenticated user authentication in the authentication requester information management module 110 is a means for preventing fraudulent use and involuntary use, such as misuse, abuse, theft, etc. of the user authentication request. For example, the system can set two passwords, one for everyday use and one for emergency use. The password for everyday use is used to receive user authentication normally, and the password for emergency use is obtained involuntarily by coercion or the like in an abnormal situation such as kidnapping. Passwords for daily use and emergency passwords can be set differently. Passwords for everyday use and emergency passwords are processed identically through the above-described procedure when requesting authentication. However, the user can selectively set an emergency password.

In addition, the user can set or select the action to be taken by the authentication management computer 1000 when the user authentication request is performed by inputting an emergency password. For example, the authentication management computer 1000 may be configured to transmit a message notifying that the user is in an emergency situation together with location information to immediate family members, lovers, or friends. In addition, it may be set to request help by directly sending a message to an investigation agency such as a police station.

In addition, in relation to the password change, the password for daily use can be changed in a normal way by accessing the authentication management computer 1000, and change of emergency password can be set to be possible only face-to-face at a specific place, such as a financial institution or community center affiliated with the identity authentication system of the present invention.

In addition, when requesting user authentication from the authentication requester terminal 5000, an input box may be configured to input the password along with a name and face photo or name and mobile phone number on the application screen of the authentication requester terminal 5000. In this case, the input order of the items entered in the input box can be entered arbitrarily, but if the input order for each item is set consistently, a procedure to check whether or not to use illegally can be performed according to the change in the input order.

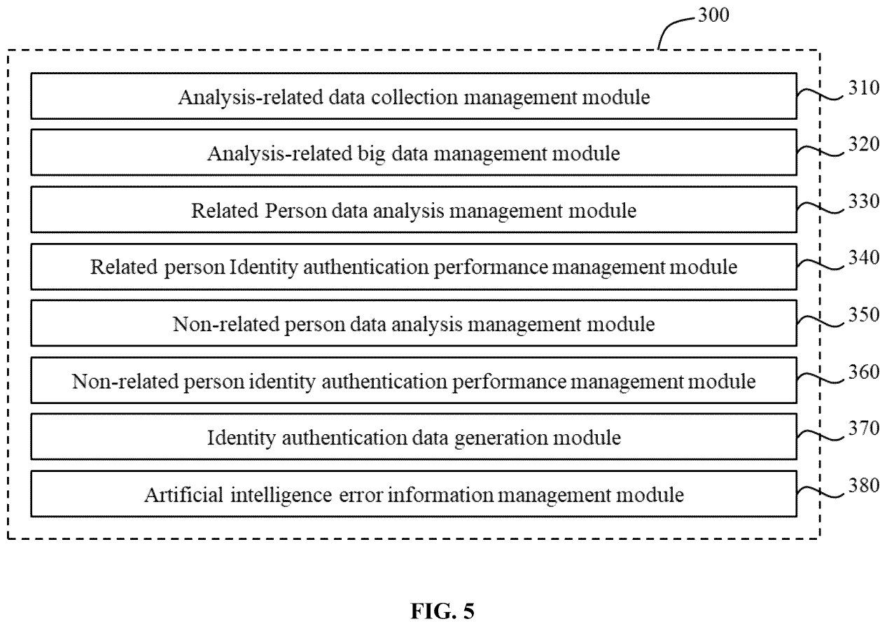

FIG. 5 is a schematic configuration diagram of an example of a data analysis computer which is a main part in the exemplary embodiment of the identity authentication system of the present invention.

The configuration of FIG. 5 may be composed of a web program utilizing hardware resources (hardware processor and memory, etc.) of the data analysis computer 3000 or an identity authentication support means expressing each configuration of a computer program as a module. The modules of each configuration are stored in the memory of the data analysis computer 3000 and implement the operation of the identity authentication system of the present invention under the control of hardware processors.

As illustrated in FIG. 5, an identity authentication support means 300 of the data analysis computer 3000 of the present invention includes an analysis-related data collection management module 310 which collects and manages data such as words, vocabularies, sentences, and expressions used in the relationship in the relationship group of the authentication requester; an analysis-related big data management module 320 which manages the data collected by the analysis-related data collection management module 310 as big data and manages update of the big data; a related person data analysis management module 330 which analyzes and manages data for each relation of a related person group based on the related person information of the authentication requester transmitted from the authentication management computer 1000; a related person identity authentication performance management module 340 which determines the identity of the authentication requester by determining the consistency of the analyzed data for each relationship and the big data; a non-related person data analysis management module 350 which analyzes and manages data for each relation of related persons and non-related persons of the non-related person group based on the information of non-related persons who are related persons of the related persons transmitted from the authentication management computer 1000; a non-related person identity authentication performance management module 360 which determines whether the related person is identical by determining the consistency of the analyzed data for each relationship and the big data; an identity authentication data generation module 370 which generates an identity authentication data of the authentication requester and transmits to the authentication management computer 1000, when the combined value of the identity authentication information of the related person identity authentication performance management module 340 and the identity authentication information of the non-related person identity authentication performance management module 360 is greater than or equal to the set value, the identity authentication data of the authentication requester is generated and stored; and an artificial intelligence error information management module 380 which manages such as an error determination method when an error occurs in the operation of the artificial intelligence (AI) program of the data analysis computer 3000, a method when the operation of the data analysis computer 3000 needs to be set manually, and how to solve problems caused by the rapid development of artificial intelligence (AI), etc.

Regarding the determination of artificial intelligence operation errors in the artificial intelligence error information management module 380, manual operation setting, and problem solving due to strong artificial intelligence, each collective intelligence convergence system (registered patent No. 10-1804960 of the present applicant)) can be used to control artificial intelligence.

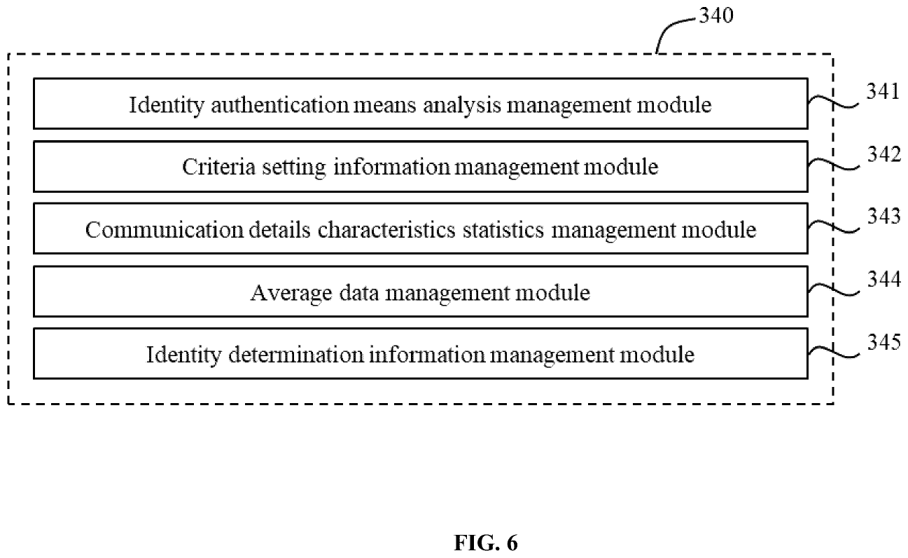

FIG. 6 is a schematic configuration diagram of an example of a related person identity performance management module which is the main part in the exemplary embodiment of the data analysis computer of the present invention.

As illustrated in FIG. 6, the related person identity performance management module 340 of the present invention includes a user authentication means analysis management module 341 which analyzes and manages communication details between a person authenticated by various existing means such as a public certificate related to personal authentication and mobile phone verification and the related person; a criterion setting information management module 342 which sets and manages a criterion of how many or more related persons should be identified for each related person group; a communication details characteristic statistics management module 343 generates and manages statistics by analyzing communication details analysis contents in the identity authentication means analysis management module 341, and the transmission and reception characteristics of the communication details between the person who have completed user authentication and the related person according to the criteria set in the standard setting information management module 342 and the related person; an average data management module 344 which calculates and manages average data of persons who have completed user authentication of transmission and reception items for each group of related persons or average data of all members; and an identity determination information management module 345 which compares and analyzes the similarity and difference with the average data for the authentication request of the authentication requester to determine whether or not the authentication is identical and manages the result.

In the standard setting information management module 342, for example, the related person group is divided into family, friends, and work, and may be set as the number of family members is at least 3, the number of friends is at least 7, and the number of office workers is at least 10.

In addition, in the communication details characteristic statistics management module 343, for example, the characteristics of transmission and reception are the number of related persons for each related person group, the total period of transmission and reception, the transmission and reception period, the number of transmission and reception, the response time between transmission and reception, name, subject, words, vocabulary, sentences, honorifics, abbreviations, whether emoticons are used, grammar, punctuation marks, whether abbreviations or informal speech are used, and peculiarities in content.

Mathematical main values such as mean, standard deviation, maximum value, and minimum value of each item related to the transmission and reception characteristics may be calculated or frequently used expressions may be stored in the analysis data storage computer 4000.

In the average data management module 344 for each related person group, for example, in order to calculate average data of transmission and reception items for each related person group, it can be prepared as shown in Table 1 below.

TABLE 1

| class | family | | friends | | work | |
|---|---|---|---|---|---|---|
| Number of related | 3 | persons | 7 | persons | 10 | persons |
| persons | | | | | | |
| Total period of | 350 | days | 7 | days | 280 | days |
| transmission and | | | | | | |
| reception | | | | | | |
| Frequency of | 5 | days | 12 | days | 2 | days |
| transmission and | | | | | | |
| reception | | | | | | |
| Number of | 2 | times/week | 1 | times/week | 3 | times/week |
| transmission and | | | | | | |
| reception | | | | | | |
| Total time of | 15 | minutes | 90 | minutes | 3 | minutes |
| transmission and | | | | | | |
| reception | | | | | | |

| | | | |
|---|---|---|---|
| Subject | meals | appointments | Work |
| Word | rice | places | Report |
| Sentence | eating | meeting | Company dinner |

The identity determination in the identity determination information management module 345 may be determined by reinforcing the criteria of other items than the average, for example, when the numerical value of a specific item, such as the number of related persons is less than the average.

For example, the transmission and reception period may be further increased, the transmission and reception period may be further reduced, the number of transmission and reception may be required more, the reaction time between transmission and reception may be further shortened, or the degree of concordance between topics, words, and sentences may be increased. On the other hand, if the number of specific items, such as the number of related persons, is greater than the average, the criteria for other items may be relaxed to determine the identity.

The system operator receives pre-entered data such as representative words, vocabularies, sentences, and expressions used in the relationship for each relationship group of the authentication requester and data provided by those who agree to use the identity authentication system of the present invention, data such as representative words, vocabularies, sentences, and expressions used in relationships are updated and accumulated. In addition, the data analysis computer 3000 accesses various social network services (SNS) and Internet media and collects expressions used in specific relationships. The analysis-related big data management module 320 of the data analysis computer 3000 may be generates data collected by system operator and data collected by the data analysis computer 3000 as a big data and stores and manages them in the analysis data storage computer 4000.

The non-related person identity authentication performance management module 360 may perform relationship identity authentication by non-related persons using the configuration of the related person identity authentication performance management module 340.

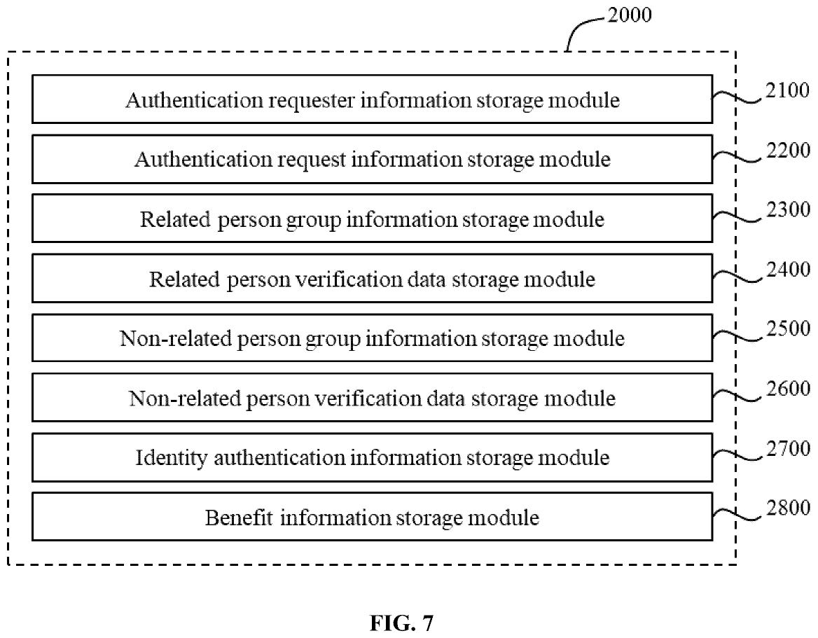

FIG. 7 is a schematic configuration diagram of an example of a data storage computer which is a main part in the exemplary embodiment of the identity authentication system of the present invention.

As illustrated in FIG. 7, a data storage computer 2000 includes an authentication requester information storage module 2100 which stores personal information and at least one password of a person who wants to be authenticated user authentication received from the authentication management computer 1000; an authentication request information storage module 2200 which stores the authentication requester's name and face photo, or name, cell phone number, and information of related persons received by the authentication management computer 1000; a related person group information storage module 2300 which groups related persons provided by the authentication requester and stores related person and related person group data; a related person verification data storage module 2400 which stores communication detail data for each related group of related person groups received by the authentication management computer 1000 and identity verification data of an authentication requester of related person groups; a non-related person group information storage module 2500 which groups non-related persons provided by related persons of the authentication requester and stores non-related persons and non-related person group data; a non-related person verification data storage module 2600 which stores communication detail data between related persons and non-related persons for each non-related group of non-related person groups received by the authentication management computer 1000 and identity verification data, etc. related person of the authentication requester and authentication requester; an identity authentication information storage module 2700 which stores identity authentication data of the authentication requester determined based on the related person identity authentication information and the non-related person identity authentication information determined by determining the consistency of the big data and the analysis result of the communication details data for each relationship group transmitted from the data analysis computer 3000; and a benefit information storage module 2800 which stores benefit information granted to related persons and non-related persons who provided communication details with the authentication requester to the authentication management computer 1000.

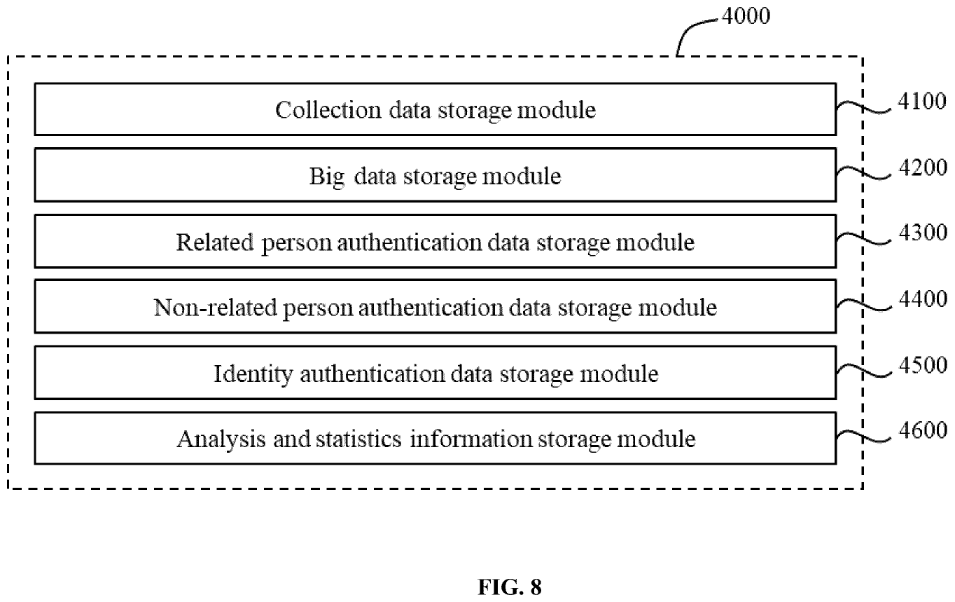

FIG. 8 is a schematic configuration diagram of an example of an analysis data storage computer which is a main part in the exemplary embodiment of the identity authentication system of the present invention.

As illustrated in FIG. 8, an analysis data storage computer 4000 of the present invention includes a collection data storage module 4100 which stores data related to identity verification of the authentication requester collected by the data analysis computer 3000 through various routes; a big data storage module 4200 which stores the collected data related to identity verification as big data and manages updates; a related person authentication data storage module 4300 which stores identity authentication data of an authentication requester of an analyzed related person; a non-related person authentication data storage module 4400 which stores identity authentication data of the related person of the analyzed non-related person and the authentication requester; an identity authentication data storage module 4500 which stores identity authentication data of the authentication requester, which is confirmed data on whether the authentication requester is the same person analyzed and determined by the data analysis computer 3000 based on identity authentication information of the authentication requester by the related persons and identity authentication information of the related person and authentication requester by the non-related persons; and an analysis and statistics information storage module 4600 which stores statistics information derived by analyzing transmission/reception characteristics of communication details between persons for whom personal authentication has been approved, related persons, and related persons and non-related persons by the data analysis computer 3000 and analysis information of related persons and non-related persons of those for whom personal authentication has been approved.

The data storage computer 2000 and analysis data storage computer 4000 are not limited to the above embodiment. Other execution results of the authentication management computer 1000 and the data analysis computer 3000 may be stored.

In the embodiment of the present invention, in the case of the identity verification of a corporation (company), where the authentication requester is not an individual, the corporation has no concern about leakage of personal information, and considering that the method of verifying the identity of a corporation is well established in the existing system, for example It can be applied by setting different criteria, such as using the address of a corporation instead of a photo, or by applying a more relaxed method of verifying identity than in the case of an individual.

For example, if the authentication requester is a corporation (corporation), the related person group can be set to at least one employee, business partner, and customer, and can be set to at least one non-related person who is their related person. As an auxiliary means to prevent fraudulent use, verification through the bank of the corporation (company), verification through corporate registration number inquiry, or verification through business registration number can be used.

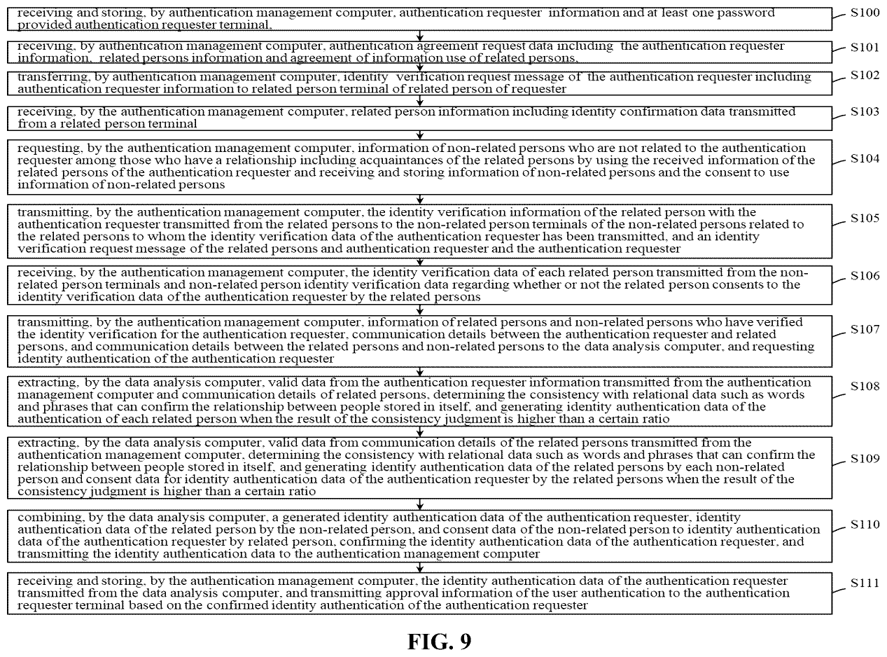

FIG. 9 is a flowchart for describing an exemplary embodiment of an identity authentication method of the present invention.

As illustrated in FIG. 9, an identity authentication method comprising: receiving, by the authentication management computer, authentication requester information and at least one password from the authentication requester terminal of the authentication requester who wants to receive user authentication, and storing the information as a member (S100); receiving, by the authentication management computer, request data of the user authentication including name and photo of the authentication requester transmitted from the authentication requester terminal, or the name and mobile phone number, and password, information of related persons stored in the communication-enabled terminal of the authentication requester, and intention to consent to the use of related persons' information (S101); transmitting, by the authentication management computer, a request message of the identity verification of the authentication requester, which includes authentication requester information including the authentication requester's name and photo, or the authentication requester's name and mobile phone number, to related terminals of related persons of the authentication requester (S102); receiving, by the authentication management computer, related persons information including the relationship with the authentication requester transmitted from the related person terminal, communication details with the authentication requester, and identity verification data necessary for determining whether the authentication requester is identical (S103); requesting, by the authentication management computer, information of non-related persons who are not related to the authentication requester among those who have a relationship including acquaintances of the related persons by using the received information of the related persons of the authentication requester and receiving and storing information of non-related persons and the consent to use information of non-related persons (S104); transmitting, by the authentication management computer, the identity verification information of the related person with the authentication requester transmitted from the related persons to the non-related person terminals of the non-related persons related to the related persons to whom the identity verification data of the authentication requester has been transmitted, and an identity verification request message of the related persons and authentication requester and the authentication requester (S105); receiving, by the authentication management computer, the identity verification data of each related person transmitted from the non-related person terminals and non-related person identity verification data regarding whether or not the related person consents to the identity verification data of the authentication requester by the related persons (S106); transmitting, by the authentication management computer, information of related persons and non-related persons who have verified the identity verification for the authentication requester, communication details between the authentication requester and related persons, and communication details between the related persons and non-related persons to the data analysis computer, and requesting identity authentication of the authentication requester (S107); extracting, by the data analysis computer, valid data from the authentication requester information transmitted from the authentication management computer and communication details of related persons, determining the consistency with relational data such as words and phrases that can confirm the relationship between people stored in itself, and generating identity authentication data of the authentication of each related person when the result of the consistency judgment is higher than a certain ratio (S108); extracting, by the data analysis computer, valid data from communication details of the related persons transmitted from the authentication management computer, determining the consistency with relational data such as words and phrases that can confirm the relationship between people stored in itself, and generating identity authentication data of the related persons by each non-related person and consent data for identity authentication data of the authentication requester by the related persons when the result of the consistency judgment is higher than a certain ratio (S109); combining, by the data analysis computer, a generated identity authentication data of the authentication requester, identity authentication data of the related person by the non-related person, and consent data of the non-related person to identity authentication data of the authentication requester by related person, confirming the identity authentication data of the authentication requester, and transmitting the identity authentication data to the authentication management computer (S110); and receiving and storing, by the authentication management computer, the identity authentication data of the authentication requester transmitted from the data analysis computer, and transmitting approval information of the user authentication to the authentication requester terminal based on the confirmed identity authentication of the authentication requester (S111).

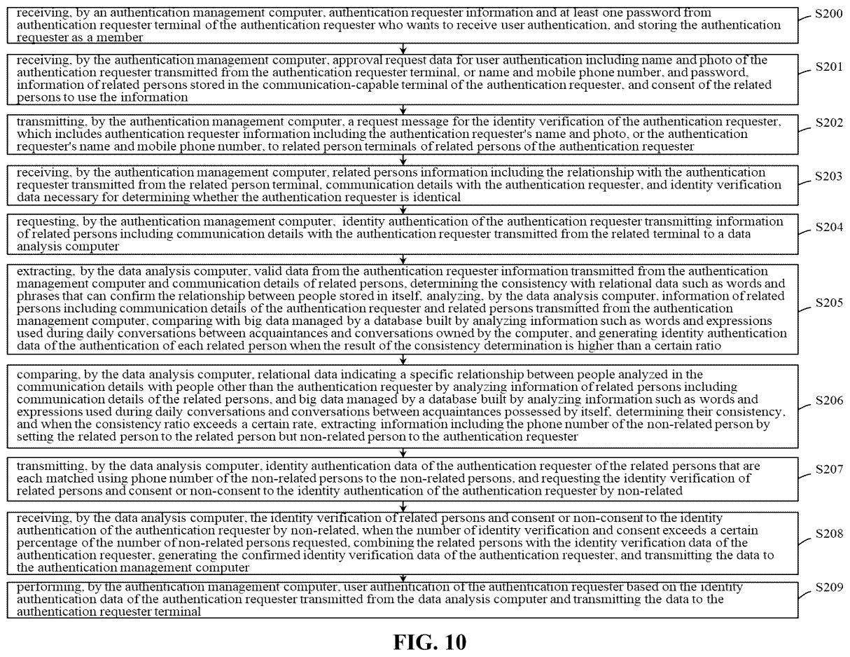

FIG. 10 is a flowchart for describing another exemplary embodiment of an identity authentication method of the present invention.

As illustrated in FIG. 10, the identity authentication method of the present invention comprising:

receiving, by an authentication management computer, authentication requester information and at least one password from authentication requester terminal of the authentication requester who wants to receive user authentication, and storing the authentication requester as a member (S200); receiving, by the authentication management computer, approval request data for user authentication including name and photo of the authentication requester transmitted from the authentication requester terminal, or name and mobile phone number, and password, information of related persons stored in the communication-capable terminal of the authentication requester, and consent of the related persons to use the information (S201); transmitting, by the authentication management computer, a request message for the identity verification of the authentication requester, which includes authentication requester information including the authentication requester's name and photo, or the authentication requester's name and mobile phone number, to related person terminals of related persons of the authentication requester (S202); receiving, by the authentication management computer, related persons information including the relationship with the authentication requester transmitted from the related person terminal, communication details with the authentication requester, and identity verification data necessary for determining whether the authentication requester is identical (S203); requesting, by the authentication management computer, identity authentication of the authentication requester transmitting information of related persons including communication details with the authentication requester transmitted from the related terminal to a data analysis computer (S204); extracting, by the data analysis computer, valid data from the authentication requester information transmitted from the authentication management computer and communication details of related persons, determining the consistency with relational data such as words and phrases that can confirm the relationship between people stored in itself, analyzing, by the data analysis computer, information of related persons including communication details of the authentication requester and related persons transmitted from the authentication management computer, comparing with big data managed by a database built by analyzing information such as words and expressions used during daily conversations between acquaintances and conversations owned by the computer, and generating identity authentication data of the authentication of each related person when the result of the consistency determination is higher than a certain ratio (S205); comparing, by the data analysis computer, relational data indicating a specific relationship between people analyzed in the communication details with people other than the authentication requester by analyzing information of related persons including communication details of the related persons, and big data managed by a database built by analyzing information such as words and expressions used during daily conversations and conversations between acquaintances possessed by itself, determining their consistency, and when the consistency ratio exceeds a certain rate, extracting information including the phone number of the non-related person by setting the related person to the related person but non-related person to the authentication requester (S206); transmitting, by the data analysis computer, identity authentication data of the authentication requester of the related persons that are each matched using phone number of the non-related persons to the non-related persons, and requesting the identity verification of related persons and consent or non-consent to the identity authentication of the authentication requester by non-related (S207); receiving, by the data analysis computer, the identity verification of related persons and consent or non-consent to the identity authentication of the authentication requester by non-related, when the number of identity verification and consent exceeds a certain percentage of the number of non-related persons requested, combining the related persons with the identity verification data of the authentication requester, generating the confirmed identity verification data of the authentication requester, and transmitting the data to the authentication management computer (S208); and performing, by the authentication management computer, user authentication of the authentication requester based on the identity authentication data of the authentication requester transmitted from the data analysis computer and transmitting the data to the authentication requester terminal (S209).

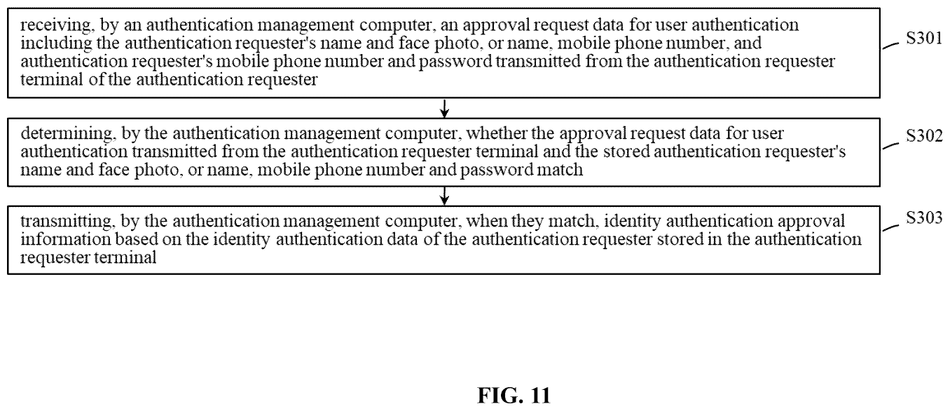

FIG. 11 is a flowchart for describing another exemplary embodiment of an identity authentication method of the present invention.

As illustrated in FIG. 11, the identity authentication method of the present invention, in the embodiment of the identity authentication method of FIGS. 9 and 10, in a state in which the authentication management computer performs identity authentication based on the identity authentication data of the authentication requester transmitted from the data analysis computer and stores it, comprising: receiving, by an authentication management computer, an approval request data for user authentication including the authentication requester's name and face photo, or name, mobile phone number, and authentication requester's mobile phone number and password transmitted from the authentication requester terminal of the authentication requester (S300); determining, by the authentication management computer, whether the approval request data for user authentication transmitted from the authentication requester terminal and the stored authentication requester's name and face photo, or name, mobile phone number and password match (S301); and transmitting, by the authentication management computer, when they match, identity authentication approval information based on the identity authentication data of the authentication requester stored in the authentication requester terminal (S302).

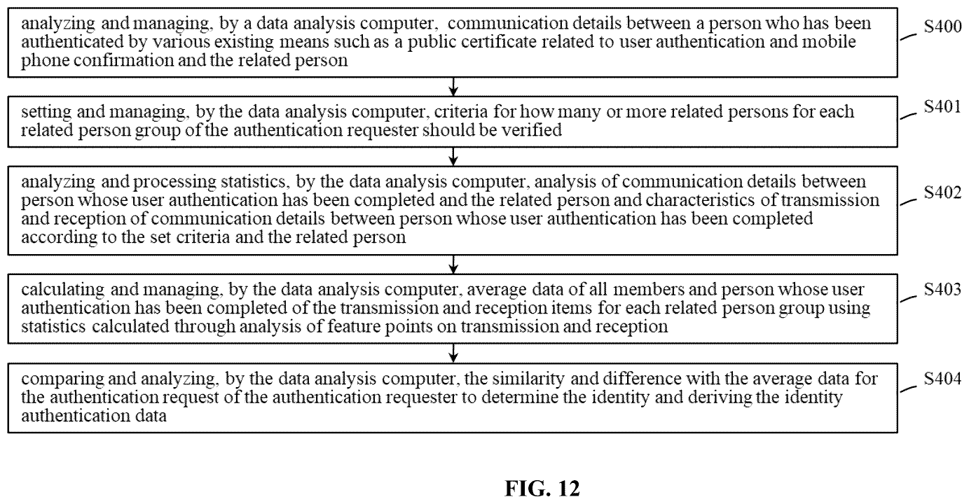

FIG. 12 is a flowchart for describing another exemplary embodiment of an identity authentication method of the present invention.

As illustrated in FIG. 12, the identity authentication method of the present invention relates to the identity authentication of the authentication requester in the embodiment of the identity authentication method of FIGS. 9 to 11, comprising: analyzing and managing, by a data analysis computer, communication details between a person who has been authenticated by various existing means such as a public certificate related to user authentication and mobile phone confirmation and the related person (S400); setting and managing, by the data analysis computer, criteria for how many or more related persons for each related person group of the authentication requester should be verified (S401); analyzing and processing statistics, by the data analysis computer, analysis of communication details between person whose user authentication has been completed and the related person and characteristics of transmission and reception of communication details between person whose user authentication has been completed according to the set criteria and the related person (S402); calculating and managing, by the data analysis computer, average data of all members and person whose user authentication has been completed of the transmission and reception items for each related person group using statistics calculated through analysis of feature points on transmission and reception (S403); and comparing and analyzing, by the data analysis computer, the similarity and difference with the average data for the authentication request of the authentication requester to determine the identity and deriving the identity authentication data (S404).

Embodiments of the identity authentication system and identity authentication method of the present invention can be summarized as inventions having the following concepts.

Assuming that there is an acquaintance relationship in steps a-b-c-d-e, the identity of a can be authenticated by b in the direct connection relationship of step 1. In addition, identity can be authenticated as an acquaintance of b by c, c by d, and d by e.

Here, based on a, a-b are related persons, but the remaining c, d, and e can be regarded as non-related persons.

In the case of identity authentication based on the step 1 relationship between a-b, incorrect authentication caused by mock or manipulation between acquaintances is fundamentally blocked and authentication by non-related persons (c, d, e) is additionally performed to minimize errors through multi-layered authentication. Thereby the accuracy and reliability of identity verification can be improved.

Here, authentication of non-related persons by c, d, and e of a is based on the identity authentication of related persons between b-c, c-d, and d-e (That is, if the identity of b, c, d is verified by c, d, e), when a is authenticated as a related person by b, the remaining c, d, and e can authenticate the identity of a as ‘non-related persons’. The meaning of authentication of identity by a non-related person is that c, d, and e do not know a well, but b, c, and d can be trusted, so that each identity for b, c, and d has been confirmed, and since a is sequentially or organically connected to c, d, and e through b, it is confirmed as a non-related person that b would not have falsely authenticated a.

When authenticating the identity of a, it may not be possible to consider whether to verify the identity of b, an acquaintance, by focusing only on a.

However, considering the characteristics of a society in which everyone is connected, if the identity of each person at the level of acquaintance b and further is verified at the same time, all people are closely connected to each other, so false or incorrect authentication has the effect of blocking in advance.

That is, if the identity of b is authenticated by c, since the identity of the principal is actually specified, it is possible to prevent malicious wrong authentication by b in authenticating a.

Embodiments of the present invention can form a huge network by securing identity (identity) by being authenticated by each acquaintance through mutual trust and collaboration, and at the same time authenticating (verifying) their acquaintances.

If the subject of identity verification according to an embodiment of the present invention is a thing other than a person (or a corporation), the identity verification of the thing can be performed using various information (communication details) transmitted and received between objects connected by communication means such as the Internet.

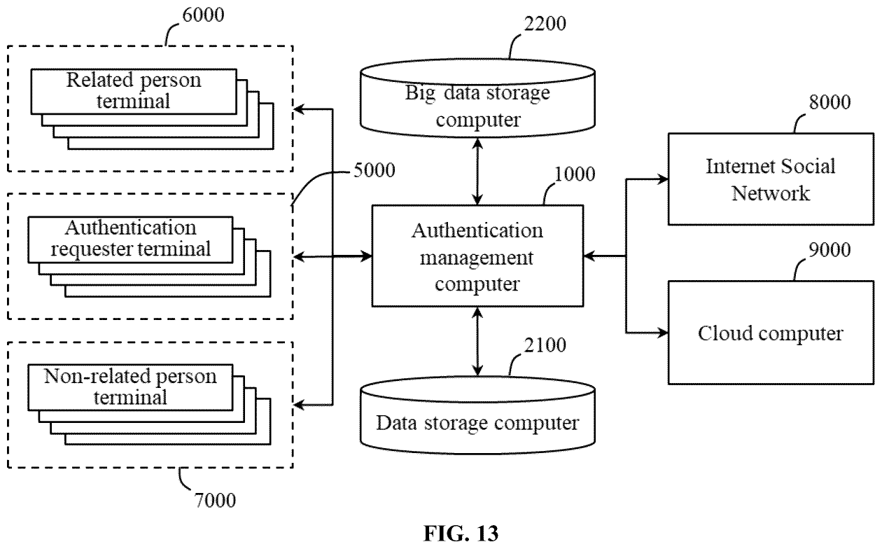

FIG. 13 is a schematic configuration diagram of another exemplary other embodiment of an identity authentication system of the present invention.

In the embodiment of the present invention, the same components and codes as those used in the above-described embodiment will be used as they are.

As illustrate in FIG. 13, the identity authentication system of the present invention includes an authentication management computer 1000 which manages information on related persons of the authentication requester, the person who received the request for authentication and at least one related person group distinguished by the nature of related persons, and non-relationship information that may be related to the related persons, but is not related to the authentication requester and at least one non-related persons group distinguished by the nature of the non-related persons, determines consistency between identity verification information of the authentication requester of related persons or non-related persons and analysis data of communication details between the authentication requester and related persons, and analysis data of communication details of related persons and non-related persons or analysis data analyzed by executing an artificial intelligence program on terminals or cloud computers of related persons and non-related persons, and big data on the relationship data of people that are owned by itself or collected through the Internet social network, performs the identity authentication of the authentication requester based on a determination result of the consistency, and manages user authentication information of the authentication requester performed based on the identity authentication; a data storage computer 2100 which stores communication details information including authentication requester information requesting user authentication, related person and related person group information managed by the authentication management computer (1000), and communication details information of the related persons including mobile phone text messages, messages sent and received using chatting application programs on mobile phones, voice calls using Internet call services, text messages through e-mail and social network services (SNS), voice using voice communication programs, etc., and non-related persons and non-related persons group information and communication details information of the non-related persons including mobile phone text messages, messages sent and received using chatting application programs on mobile phones, voice calls using Internet call services, text messages through e-mail and social network services (SNS), voice using voice communication programs, etc., and identity verification information of the authentication requester by the related persons and non-related persons, communication details information of the related persons and non-related persons, identity authentication information of the authentication requester generated by determining consistency with big data owned by the computer, and user authentication information of the authentication requester performed based on the identity authentication information; a big data storage computer 2200 which stores relational data such as representative words, vocabularies, sentences, and expressions used in each corresponding relation of a set relation group by distinguishing the person-person relationship input from the operator by nature, updates relational data such as representative words, vocabularies, sentences, and expressions used in the relationship among data provided by authentication requesters, related persons and non-related persons, etc., executes an artificial intelligence program of the authentication management computer 1000 to access an external Internet social network, collects and stores relational data such as representative words, vocabularies, sentences, and expressions used in specific relationships, and manages its own updated relational data and relational data collected from the Internet social network as big data; a user authentication approval request means provided in the authentication requester terminal (5000) of the authentication requester that is connected to the authentication management computer (1000) to request user authentication and to receive approval information of the user authentication; a related person identity verification providing means provided in at least one related person terminal 6000 which provides information such as relationship information and communication details with the authentication requester to the authentication management computer 1000 connected by communication by related persons such as acquaintances related to the authentication requester, or may be access and collect information such as relationship information and communication details with an authentication requester through an artificial intelligence program by the authentication management computer; and provides identity verification information of the authentication requester or consent information of the related persons to the identity verification of the authentication requestor according to the request of the authentication management computer 1000; an internet social network 8000 such as a social network through which the authentication management computer 1000 communicates and collects relational data such as words, phrases, vocabularies, and expressions that characterize the relationships between people; and a cloud computer 9000 through which the authentication management computer 1000 communicates and connects to the related persons or collects relational data of the non-related persons in a virtual space provided and stored by non-related persons having a relationship with the related persons.

The cloud computer 9000 may be configured to basically provide a virtual space to all participants including the authentication requester, related persons, and non-related persons, and to manage big data by collecting and updating relationship data between people or between people through an artificial intelligence program, to be performed the consistency between communication details transmitted and received between the authentication requester and related persons or between related persons and non-related persons and information analyzed by big data in a separate program or process of the cloud computer itself, which is independent or separated from the authentication management computer.

In the embodiment of the sameness authentication system of FIG. 13, since most of the descriptions of each component of the sameness authentication system of FIG. 1 are shared, many parts of the description are omitted.

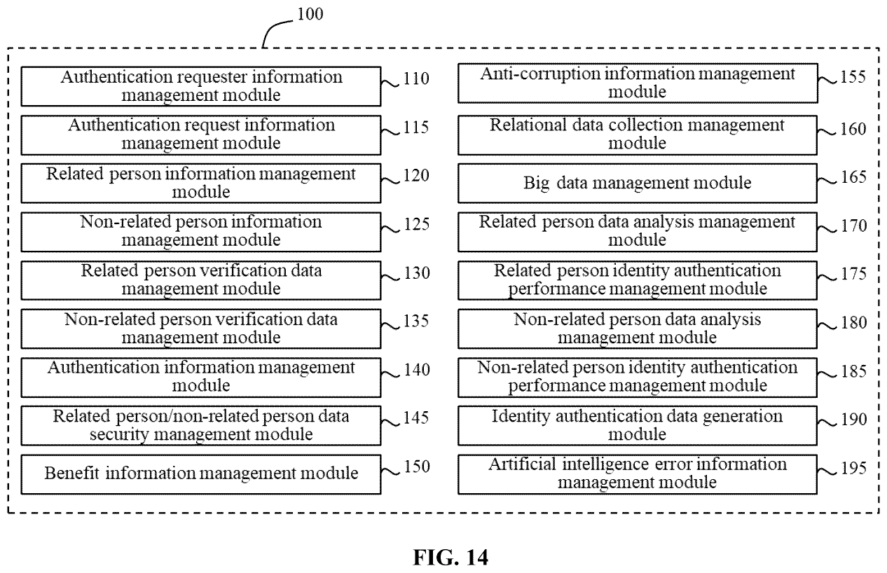

FIG. 14 is a schematic configuration diagram of an example of an authentication management computer which is a main part in the exemplary embodiment of the identity authentication system of FIG. 13 of the present invention.

Among the components of the authentication management computer 1000 of FIG. 14, only the names of the components overlap with those of the authentication management computer 1000 of FIG. 2 are listed and described, and descriptions thereof are omitted.

The configuration of FIG. 14 may be composed of a web program utilizing hardware resources (hardware processor and memory, etc.) of the authentication management computer 1000 or identity authentication management means expressing each component of a computer program as a module. The modules of each component are stored in the memory of the authentication management computer 1000 and implement the operation of the identity authentication system of the present invention under the control of hardware processors.

As illustrate in FIG. 14, the identity authentication management means 100 composed of a computer program executed in the authentication management computer 1000 of the present invention includes authentication requester information management module 110, authentication request information management module 115, related person information management module 120, non-related person information management module 125, related person verification data management module 130, non-related person verification data management module 135, authentication information management module 140, related person/non-related person data security management module 145, benefit information management module 150, anti-corruption information management module 155, a relational data collection management module 160 which stores and manages relational data such as a representative word, vocabularies, sentences, and expressions used in each corresponding relationship of a relationship group established by distinguishing the relationship between a person and a person input from the operator by personality, updates relational data such as representative words, vocabularies, sentences, and expressions used in the relationship among data provided by authentication requesters, related persons and non-related persons, etc., and collects and manages relational data such as representative words, vocabularies, sentences, and expressions used in a specific relationship by executing an artificial intelligence program by the authentication management computer 1000 to access an external Internet social network 8000; a big data management module 165 which manages update of self-owned updated relation data collected and managed by the relation data collection management module 160 and relation data collected from the Internet social network into big data; a related person data analysis management module 170 which manages a relational data such as representative words, vocabularies, sentences, expressions, etc. used in a specific relationship by analyzing data for each relationship of a related person group in the communication details between the authentication requester and related people stored in the data storage computer 2100; a related person identity authentication performance management module 175 which verifies the identity of the authentication requester by determining the consistency of the analyzed relational data and big data of the analyzed authentication requester and related persons; a non-related person data analysis management module 180 which manages relationship data such as representative words, vocabularies, sentences, and expressions used in a specific relationship by analyzing data for each relationship of a non-related person group in the communication details between the related person and non-related persons stored in the data storage computer 2100; a non-related person identity verification performance management module 185 which authenticates the identity of the related persons of non-related persons by determining the consistency of the relationship data and big data of the analyzed related person and non-related person, and determines whether the related persons whose identity has been authenticated by non-related persons consent the identity verification of the authentication requester; an identity authentication data generation module 190 which collects the identity authentication information of the related person identity authentication performance management module 175 and the identity authentication information of the non-related person identity authentication performance management module 185, and if the value is greater than or equal to the set value, generates identity authentication data of the authentication requester and stores the identity authentication data to the data storage computer 2100; and an artificial intelligence error information management module 195 which manages an error determination method when an error occurs in the operation of the artificial intelligence (AI) program of the authentication management computer 1000, a method when the operation of the authentication management computer 1000 needs to be manually set, and how to solve problems caused by the rapid development of artificial intelligence (AI), etc.

In the embodiments of FIGS. 13 and 14, an authentication requester as a, a related person as b, and a non-related person as c as an example, the operation will be described in detail. The embodiment of the identity authentication system of the present invention of FIGS. 13 and 14 is to specify the role of a non-related person in the embodiment of FIGS. 1 to 12.

Basically, the communication details between a and b are analyzed, and the identity of a is authenticated by comparing the consistency using the big data possessed by the system of the present invention. The big data is data that is owned by the system of the present invention or collected from the Internet, etc., and is used to perform artificial intelligence functions that strengthen the ability to determine consistency by accumulating conversation contents that can be made in a specific relationship and performing machine learning (machine learning).

In addition, in the embodiments of FIGS. 13 and 14, the authentication management computer 1000 determines consistency. However, if the authentication management computer 1000 or the big data for determining consistency is contaminated or manipulated by hacking, problems may occur in the entire function. In order to prevent this problem and to perform identity authentication in multiple layers, it can be configured to perform the role through a non-related person c. This is a configuration to prevent problems with the entire function of the system when the authentication management computer 1000 or the big data for consistency determination are stigmatized or manipulated by hacking or the like.

The non-related person c analyzes the communication details of a-b to analyze the conversation contents that can be made in a specific relationship and to determine the consistency, it may be configured to verify by executing a separate artificial intelligence program on a terminal of the non-related person c or virtual cloud computer.

In this case, since the authentication management computer improves its performance through machine learning in the same way as the authentication management computer 1000, there may be some differences in performance between the authentication management computer and non-related person terminals or cloud computers. However, since the relationship between a-b is analyzed and authenticated by artificial intelligence programs of various levels, it can rather contribute to improving the objectivity or reliability of analysis and authentication.

c, a non-related person of a, can be an unspecified number of people and can be randomly set, such as randomly designated, so that it is free from manipulation or contamination such as hacking, so that the relationship between a and b can be more accurately verified and authenticated. Here, since the work performed in the terminal of the non-related person c or the cloud computer can be configured to be automatically executed by the program, c does not have to manually manipulate it, and the corresponding work can be done 24 hours a day, 365 days a year.

However, while a-b is a direct party to the communication contents, c is a non-relationship with a, so a may want to keep the communication details between a-b confidential from c or not to disclose the contents such as the communication details. Therefore, it is desirable to analyze the content in an encrypted state using homomorphic encryption technology for the authentication task of a by c and then perform the authentication task.

The embodiment of the identity authentication system of FIGS. 13 and 14 has the following characteristics.

First, since the identity of a is authenticated through b whose identity is authenticated by c, etc., the reliability of authentication is increased compared to when b, which has not been authenticated, authenticates the identity of a.

In other words, if the identity of each other is verified even in the relationship after c, c-d-e-f-, etc., due to the effect that all participants in the network are verified, it is possible to block or prevent criminal acts such as maliciously erroneously authenticating someone or manipulating someone in a state where the user has been identified by the around related person.

Second, as a countermeasure in case the authentication management computer is contaminated or malfunctions due to hacking, etc., it is a configuration that can authenticate the identity of a by analyzing the communication details of a-b using an artificial intelligence program on a terminal operated separately by a non-related person or a cloud computer.

More specifically, a consistency determination means including an artificial intelligence program that performs the same function as the consistency determination performed by the authentication management computer and is executed independently of the authentication management computer is mounted on at least one of the cloud computer, authentication requester terminal, related person terminal, and non-related person terminal, and when it is detected that a problem such as hacking of the authentication management computer or contamination of big data has occurred, the consistency determination is performed by at least one consistency determination means among the cloud computer, the authentication requester terminal, related person terminals, and non-related person terminals. In addition, the virtual space of the cloud computer can be provided to all participants of the system operator of the present invention, authentication management requesters, related persons and non-related persons.

In addition, as another embodiment of the present invention, the authentication management computer, the terminals used by the authentication requester, the related persons, and the non-related persons and cloud computers are provided with, respectively, consistency determination means determining the consistency between relational data representing specific relationships between people analyzed from communication details information between the authentication requester and related persons of the authentication requester and communication detail information between non-related persons who are not related to the authentication requester and related persons and big data including own relational data, and the authentication management computer, terminals used by the authentication requester, related persons, and non-related persons and cloud computers each of the consistency determination means are executed to perform the consistency determination, respectively, when the result of consistency determination in each consistency determination means is inconsistent, it may be configured to determine the consistency with a majority decision.

The embodiment of the present invention is a configuration for always performing identity authentication of an authentication requester in multiple layers, and errors in system operation or hacking are not only big data of the authentication management computer, but also can occur in terminals and cloud computers used by authentication requesters, related persons, and non-related persons. In order to overcome this problem, consistency determination is performed not only on the authentication management computer, but also on terminals and cloud computers used by authentication requesters, related persons, and non-related persons. Accordingly, when there is inconsistency in each conformity determination, the conformity determination is performed with a majority decision, thereby increasing the reliability of the system.

If the conformity determination performed by each conformity determination means is inconsistent, the subject who determines the conformity with a majority can perform it in any one of the above-mentioned consistency determination means, preferably the authentication management computer.

In addition, the relational data in the big data used for the consistency determination performed by each of the consistency determination means may use big data held by each consistency determination means, preferably, the big data stored in the authentication management computer or the big data storage computer is used.

Terms and expressions used in the above embodiments of the present invention are not limited thereto. It goes without saying that it can be replaced with various words and expressions that a person skilled in the art can predict.

In addition, the embodiments of the present invention described above are only some of various embodiments of the present invention.

It is natural that the various embodiments included in the technical idea of the present invention fall within the scope of protection of the present invention, in which with the personal information of the authentication requester, a request for user authentication is made to the authentication management computer, and the data analysis computer determines the consistency between the relational data extracted by analyzing communication details information between related persons such as acquaintances of the authentication requester and authentication requester, and communication details between related persons and non-related persons who are related to the related person but not related to the authentication requester and the related big data collected by the data analysis computer, and identity authentication approval is only possible when those related and non-related persons confirm that the authentication requester is the same person.

The present invention can be used in the field of user authentication with enhanced online security.

What is claimed is:

1. An object identity authentication system comprising:
an operating computer configured to collect and manage communication details exchanged between objects connected via a network, to analyze the communication details to generate identity-related data, and to determine consistency between the identity-related data and relationship big data retained by the system so as to generate identity authentication information of an object;
a data storage computer configured to store the communication details and the identity authentication information; and
a big data storage computer configured to store the relationship big data used for the consistency determination;
wherein, when the consistency satisfies a preset percentage, the operating computer generates identity verification information of the object and generates the identity authentication information based on the identity verification information.

2. The system of claim 1, wherein the communication details include at least one of mobile phone text messages (SMS, MMS), chat messages in chat application programs, text communications on social networking services, e-mail letters, Internet voice calls, and other communication details exchanged between objects connected via a network.

3. The system of claim 1, wherein the operating computer transmits the communication details to an analyzing computer to request provision of identity-related data, and determines the consistency using the identity-related data provided by the analyzing computer.

4. The system of claim 1, wherein determining the consistency comprises calculating a similarity index, and the preset percentage is set according to a criterion that is strengthened or relaxed.

5. The system of claim 1, wherein the data storage computer stores, per object, the communication details, identity-related data, consistency history, and identity authentication information in association with an identifier, and the operating computer performs a simplified re-authentication procedure based on the history.

6. An object identity authentication method comprising:
receiving, by an operating computer, communication details exchanged between objects connected via a network;
analyzing, by the operating computer, the communication details to derive identity-related data;
determining, by the operating computer, consistency between the identity-related data and relationship big data of the system;
generating, by the operating computer, identity verification information of a target object when the consistency exceeds a preset percentage; and
generating, by the operating computer, identity authentication information of the target object based on the identity verification information.

7. The method of claim 6, further comprising collecting, together with the communication details, transmission/reception characteristics including at least one of a period, a number of transmissions or receptions, and a response time.

8. The method of claim 6, wherein analyzing the communication details comprises generating features including at least one of representative words, vocabulary, sentences, and expressions used in a specific relationship, and transmission/reception characteristics including period, number, and response time, and comparing similarities and differences with average data.

9. The method of claim 6, further comprising transmitting, by the operating computer, the communication details to an analyzing computer to request provision of identity-related data, and determining the consistency using the identity-related data provided by the analyzing computer.

10. The method of claim 6, further comprising, when the consistency is below the preset percentage, performing at least one of acquiring additional communication details, reanalyzing the communication details, and adjusting the criterion, and then redetermining whether to generate the identity verification information and the identity authentication information.

11. The system of claim 1, wherein the object comprises a computer program configured to perform autonomous tasks.

12. The system of claim 1, wherein the communication details are encrypted using homomorphic encryption, and wherein the operating computer analyzes the communication details in their encrypted state to generate the identity-related data.

13. The system of claim 1, wherein the identity-related data includes features comprising at least one of communication protocols, data payload formats, API call sequences, or resource access patterns characteristic to a specific relationship between the objects.

14. The method of claim 6, wherein the target object comprises a computer program configured to perform autonomous tasks.

15. The method of claim 6, further comprising analyzing, by the operating computer, the communication details in their encrypted state using homomorphic encryption to derive the identity-related data.

16. The method of claim 8, wherein the features further include at least one of communication protocols, data payload formats, API call sequences, or resource access patterns characteristic to the specific relationship between the objects.
